(19) United States
(12) Patent Application Publication
(10) Pub. No.: US 2006/0279966 A1
(43) Pub. Date: Dec. 14, 2006

(54) Simple zero voltage switching full-bridge DC bus converters

(75) Inventors: Weidong Fan, Torrance, CA (US); Goran Stojcic, Redondo Beach, CA (US)

Correspondence Address: OSTROLENK FABER GERB & SOFFEN, 1180 AVENUE OF THE AMERICAS, NEW YORK, NY, 100368403, US

(73) Assignee: International Rectifier Corp.

(21) Appl. No.: 11/408,814

(22) Filed: Apr. 13, 2006

Related U.S. Application Data
(60) Provisional application No. 60/670,830, filed on Apr. 13, 2005.

(51) Int. Cl. H02M 3/335

(52) U.S. Cl. 363/17

(57) ABSTRACT

A method and circuit arrangement for achieving zero voltage switching (ZVS) in a 50% duty cycle full-bridge DC bus converter. The ZVS is obtained by increasing the transformer magnetizing current. During the small dead time between conductions of the two bridge legs, the increased magnetizing current supports the output inductor current, and resonates with MOSFET output capacitance, resulting in ZVS operation. With ZVS operation, body diode conduction and voltage spikes across the secondary synchronous rectifiers are reduced, full load efficiency is increased, and transformer flux balance is enhanced.

### CROSS-REFERENCE TO RELATED APPLICATION

This application claims the benefit and priority of U.S. Provisional patent application Ser. No. 60/670,830 filed Apr. 13, 2005 entitled SIMPLE ZERO VOLTAGE SWITCHING FULL-BRIDGE DC BUS CONVERTER, the entire disclosure of which is incorporated herein by reference.

### BACKGROUND OF THE INVENTION

1. Field of the Invention

The present invention relates to a DC-DC converter, and more particularly to a DC-DC converter adapted for zero-voltage switching in its primary circuit.

2. Related Art

Half-bridge and full-bridge isolated DC-DC converters with fixed 50% duty cycle are excellent choices for 48V DC bus converters. A half-bridge converter is used at low power levels (below about 150 W). Key benefits of the half-bridge converter are simplicity, robustness and inherent protection against transformer flux imbalance. A full bridge converter is a good choice for higher power levels, or when a better resolution of transformer turns ratios is required (5:1, for example).

In a full-bridge converter, flux imbalance is a greater consideration. It is more difficult for a full-bridge bus converter to match the pulse width durations across the transformer than for a half-bridge converter. This is because two FETs in each bridge leg must be on at the same time, so that there are four rise/fall times to match, as opposed to two in a half-bridge converter. Any pulse width mismatch can be compounded and results in undesirable transformer flux imbalance.

Traditionally, full-bridge converters are operated with peak current mode control to protect against transformer core saturation that can theoretically result from even a small mismatch between the conduction times of the two legs of the bridge. However, current mode control is not an option for a fixed 50% duty cycle converter. Another way to compensate for pulse width variation is simply to allow one leg of the bridge to conduct more current, and compensate for the pulse width mismatch with larger resistive drop across the FETs and primary winding of the transformer. However, this raises device temperatures and limits the total power that the converter can deliver.

### SUMMARY OF THE INVENTION

The present invention provides an elegant practical solution for the full-bridge converter issues identified above. The solution is based on achieving zero voltage switching (ZVS) on the primary side (secondary synchronous rectifiers are already switched with ZVS).

A few simple techniques have been proposed in the past to get zero voltage switching (ZVS). A leakage inductance was proposed in a fixed 50% duty cycle half bridge DC bus converter design [H. Mao, J. Abu-Qahouq, S. Luo and I. Batarseh, “Zero-Voltage-Switching (ZVS) Two-Stage Approaches with Output Current Sharing for 48 V Input DC-DC Converter”, IEEE APEC 2004, pp 1078-1082]. However, no efficiency data was given, and the leakage inductance may result in additional power loss. Other two common ZVS techniques in a complementary (asymmetric) ZVS half bridge DC-DC converter [D. Sterk, M. Xu, Y. Ren and F. Lee, “Novel Integrated Transformer Winding Scheme for Self-Driven ZVS Interleaved Asymmetrical Half-Bridge For Telecommunications Quarter Brick”, IEEE APEC 2004, pp 912-918; W. Eberle, Y. Han, Y. Liu and S. Ye, “An Overall Study of the Asymmetrical Half-Bridge with Unbalanced Transformer Turns under Current Mode Control”, IEEE APEC 2004, pp 1083-1089] and a duty cycle shift (DCS) half bridge converter [H. Mao, S. Deng, J. Abu-Qahouq and I. Batarseh, “A Modified ZVS Half-Bridge DC-DC Converter”, IEEE APEC 2004, pp 1436-1441; Y. Jang and M. Jovanovic, “A New Family of Full-Bridge ZVS Converter”, IEEE Trans. On Power Electronics, Vol. 19(3), 2004, pp 701-708] targeted for a regulated output voltage. Both needed additional switches and a controller for timing control. For DC bus converters, the dead time is usually less than 100 ns, and to get timing control signals during that short period would be very difficult.

According to a feature of the invention, ZVS is achieved by increasing the magnetizing current of the transformer. According to a preferred embodiment, this may be done by providing a small air gap in the transformer, which increases the magnetizing current so that during dead times the increased magnetizing current can support the output current and discharge output capacitors of the primary FETs, which will be turned on during the next period.

One aspect of the invention provides a DC-DC converter comprising a plurality of semiconductor switching devices connected in a bridge configuration and controllable to convert a DC source voltage to a primary AC current; a transformer having a primary, a secondary, and a core; said primary being connected to said bridge for receiving said primary AC current; said secondary outputting a secondary AC current; and a secondary circuit for rectifying said secondary AC current to provide a DC output voltage; wherein said transformer has an air gap, which increases the magnetizing current in said transformer.

Another aspect of the invention provides a method of improving switching in a DC-DC converter, said converter comprising a plurality of semiconductor switching devices connected in a bridge configuration and controllable to convert a DC source voltage to a primary AC current; a transformer having a primary, a secondary, and a core; said primary being connected to said bridge for receiving said primary AC current; said secondary outputting a secondary AC current; and a secondary circuit for rectifying said secondary AC current to provide a DC output voltage; the method comprising the step of increasing the magnetizing current of the transformer. According to a preferred embodiment, this may be done by providing an air gap in the transformer so as to increase the magnetizing current in said transformer and thereby support the said primary AC current and discharge output capacitance's of said plurality of semiconductor switching devices.

The DC-DC converter may include a primary circuit including a plurality of semiconductor switches connected to form a bridge for receiving a DC source voltage and outputting a primary AC current; said switches of said bridge being turned on and off by respective control pulses having dead times defined between said pulses; a transformer having a primary, a secondary, and a core; said primary being connected to said primary circuit for receiving said primary AC current and outputting a secondary AC current; and a secondary circuit for rectifying said secondary AC current and providing a DC output voltage; said transformer having an air gap which causes a magnetizing current of said transformer to circulate to said primary circuit during said dead times so as to support said primary AC current during said dead times.

The semiconductor switches may be FETs having body capacitors, wherein the magnetizing current discharges said body capacitors.

The bridge may be a full bridge comprising four of said FETs.

A primary inductor may be connected across said transformer primary.

In the method, the DC-DC converter may comprise a primary circuit including a plurality of semiconductor switches connected to form a bridge for receiving a DC source voltage and outputting a primary AC current; said switches of said bridge being turned on and off by respective control pulses having dead times defined between said pulses; a transformer having a primary, a secondary, and a core; said primary being connected to said primary circuit for receiving said primary AC current and outputting a secondary AC current; and a secondary circuit for rectifying said secondary AC current and providing a DC output voltage; said method comprising the step of increasing the magnetizing current of the transformer. According to a preferred embodiment, this may be done by providing said transformer with an air gap so as to increase a magnetizing current of said transformer and circulate said magnetizing current to said primary circuit during said dead times so as to support said primary AC current during said dead times.

The solution is demonstrated in a practical 240 W DC bus converter. The ZVS solution may not reduce power losses of the primary FETs, since reduction of turn-on switching loss comes at the expense of increased conduction loss and increased turn-off loss. However, ZVS has the considerable advantages of reducing losses on the secondary, especially due to body diode conduction and voltage spikes across the secondary synchronous rectifiers, allowing use of lower voltage rating devices, increasing full load efficiency, improving EMI, and enhancing transformer flux balance without asymmetrical bridge currents.

Other features and advantages of the present invention will become apparent from the following description of embodiments of the invention, which refers to the accompanying drawings.

### BRIEF DESCRIPTION OF THE DRAWINGS

FIG. 1 is a schematic diagram of the full-bridge converter according to an embodiment of the invention.

FIG. 2(a) shows simplified circuit waveforms for a normal hard-switched operation, without ZVS.

FIG. 2(b) shows waveforms for a soft-switched operation including ZVS.

FIG. 3 is a graph of minimum magnetizing inductance for soft switching as a function of input voltage.

FIG. 4 shows detailed switching waveforms during a dead time with ZVS.

FIG. 5 is a graph of magnetizing inductance versus input voltage.

FIG. 6 is a graph showing minimum magnetizing current, ZVS transition time and commutation time versus total switch capacitance.

FIG. 7 is a graph showing efficiency versus load with and without ZVS, for a given input voltage.

FIG. 8 is a graph showing primary magnetizing current for a given input voltage and output current, with and without ZVS.

FIGS. 9(a) and 9(b) show waveforms for the secondary switches without ZVS and with ZVS; respectively.

FIG. 10 shows temperatures in the experimental device.

### DETAILED DESCRIPTION OF EMBODIMENTS OF THE INVENTION

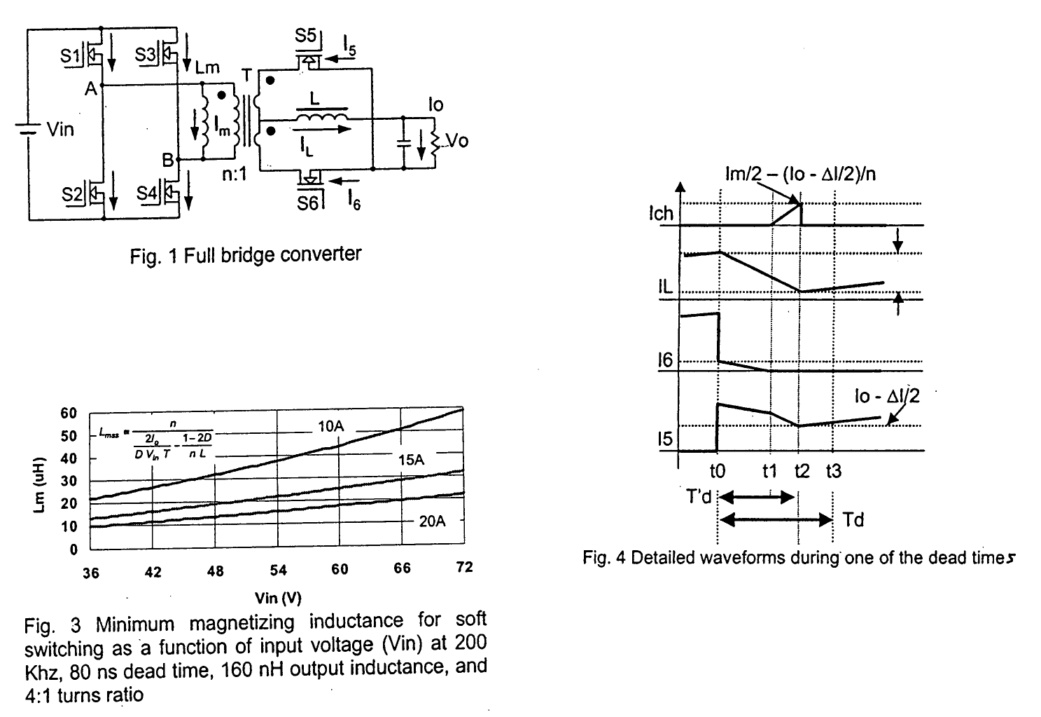

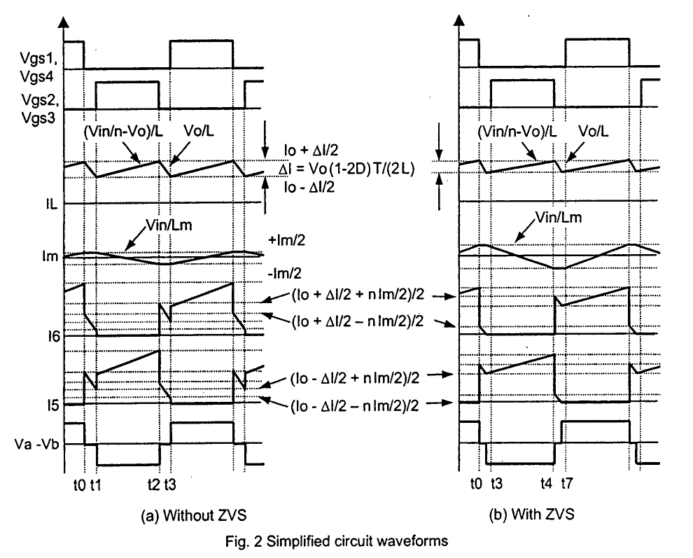

An isolated full-bridge dc-dc converter with self-driven secondary synchronous rectification is shown in FIG. 1. FIG. 2(a) shows simplified circuit waveforms for a normal hard-switched operation, without ZVS. These waveforms assume that S₁ and S₄ have the same pulse width (Vgs1 and Vgs4) as S₂ and S₃ (Vgs2 and Vgs3). Therefore, the magnetizing current is symmetrical. The input and output capacitance is assumed very high, so that output inductor current ripple changes linearly, and is in continuous conduction mode.

In the hard-switched case of FIG. 2(a), the primary magnetizing current moves to the secondary side during the dead time, and it does not commutate back to the primary side until the beginning of the next switching cycle. During the dead time, the transformer windings are shorted, and the current flowing through the secondary windings can be calculated from the following two equations:

$$\begin{matrix}\vert {I}_{5} - {I}_{6} \vert = \frac{{nI}_{m}}{2} & ( 1 ) \\ {I}_{5} + {I}_{6} = {I}_{L} & ( 2 )\end{matrix}$$

In (1) and (2), I_{L} is the inductor current, Iₘ is the peak-to-peak value of the transformer magnetizing current, and n is the turns ratio. During the dead time, the magnetizing current is constant. This magnetizing current makes one of the secondary currents higher than the other, as shown in FIG. 2(a). Minimum values of 15 and 16 are reached at the end of the dead time (the valley of the inductor ripple current). For a hard-switched case, neither 15 nor 16 reaches zero before the dead time is over, and the following equation is satisfied:

$$\begin{matrix}{I}_{m} < \frac{2 {I}_{o} - Δ I}{n} \\ where \text{:} & ( 3 ) \\ Δ I = \frac{{DV}_{in} ( 1 - 2 D ) T}{nL} & ( 4 )\end{matrix}$$

During the dead time, the magnetizing current remains on the secondary. In equation (4), D is the duty cycle of the primary switches, and T is the switching period.

To achieve ZVS, part of the magnetizing current needs to commutate back to the primary to initiate the soft switching transition. Simplified circuit waveforms are shown in FIG. 2(b). In this figure, the equations (1) and (3) are not satisfied during the whole dead time. Either 15 or 16 reaches zero before the end of dead time. This forces the body diode of either S₅ or S₆ to stop conducting. At the instant when S₅ or S₆ current reaches zero, the magnetizing current will completely support the output inductor current. As the inductor current continues to decrease for the remainder of the dead time, a portion of the magnetizing current will commutate back to the primary side and start to resonate with the output capacitors of the switches S₁-S₆. In order to get the soft switching, the magnetizing current must satisfy:

$${I}_{m} ≡ \frac{{DV}_{in} T}{{L}_{m}} > \frac{2 {I}_{o} - Δ I}{n} \qquad ( 5 )$$

Combining equations (4) and (5), the magnetizing inductance required for soft switching Lₘₐₛₛ can be calculated as:

$${L}_{m} < {L}_{mss} ≡ \frac{n}{\frac{2 {I}_{o}}{{DV}_{in} T} - \frac{1 - 2 D}{nL}} \qquad ( 6 )$$

It can be seen from (6) that soft switching can be obtained either by reducing the magnetizing inductance to increase the magnetizing current, or by reducing the output filter inductance to decrease the valley of the inductor current ripple.

The minimum required magnetizing inductance versus input voltage under a typical condition is shown in FIG. 3. At 48 V input and 20 A output, the magnetizing inductance has to be less than 14 uH to achieve soft switching. FIG. 3 shows minimum magnetizing inductance for soft switching as a function of input voltage (Vin) at 200 kHz, 80 ns dead time, 160 nH output inductance, and 4:1 turns ratio.

Note that Eq. 6 indicates the required inductance to initiate soft switching, but does not show the inductance required for achieving ZVS switching. The required inductance for ZVS depends on switch output capacitances, such that the larger the capacitance, lower the inductance will be required for ZVS.

FIG. 4 shows detailed switching waveforms during one of the dead times with ZVS. It is assumed that the inductor current decreases linearly during the dead time. Between t₁ and t₀, all the waveforms are the same as those without ZVS. At t₁, I₆ drops to zero. Between the t₁ and t₂, the I₅ has to be equal to the inductor current. This interval will be called transition time. Assuming that the inductor current continues decreasing linearly, I₅ will also decrease linearly. Therefore, equation (1) cannot be maintained.

In FIG. 4, the portion of the magnetizing current that commutates back from secondary to primary is denoted as I_{ch}. During the transition time, L_{ch} charges and discharges switch output capacitors. Energy stored in Lₘ, has to be high enough to completely charge and discharge total output capacitance of all the switches before the dead time expires.

ZVS condition can be estimated based on the linear assumption from FIG. 4. The commutation time t₁-t₀ and the transition time t₂-t₁ can be calculated from following equations (7) and (8):

$$\begin{matrix}{t}_{1} - {t}_{0} = \frac{L ( 2 {I}_{o} + Δ I - {nI}_{m} )}{4 {V}_{o}} & ( 7 ) \\ {Q}_{T} = \frac{{t}_{2} - {t}_{1}}{2} ( \frac{{I}_{m}}{2} - \frac{2 {I}_{o} + Δ I}{2 n} ) & ( 8 )\end{matrix}$$

where Q_{T} is the total equivalent charge of the output capacitance of all the switches. With ZVS, the dead time, T_{d}′ and output voltage, Vₒ is defined as

$${V}_{o} = \frac{( T - 2 {T}_{d}^{′} ) {V}_{in}}{T} \qquad ( 9 )$$

where T_{d}′=t₂-t₀, as defined in FIG. 4. Combining the equations (7-9) with (4-5), ZVS conditions can be estimated. The minimum inductance for ZVS can be calculated from T′=T_{d}.

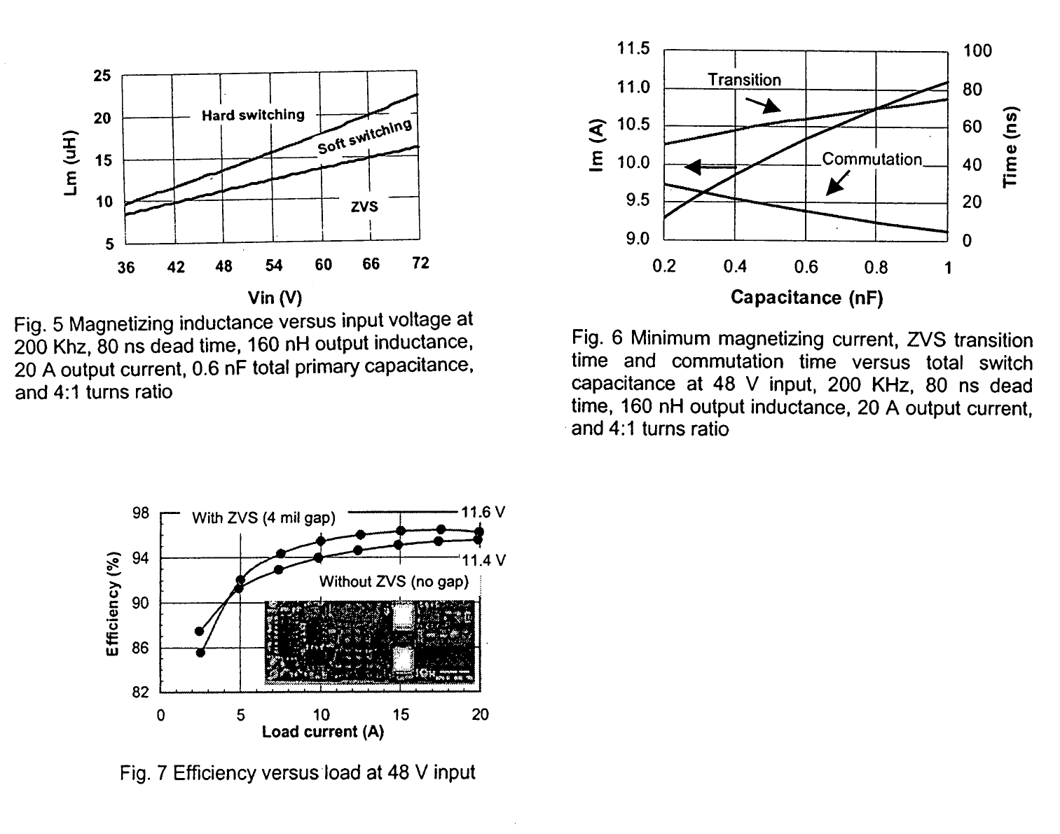

FIG. 5 shows magnetizing inductance versus input voltage at 200 kHz, 80 ns dead time, 160 nH output inductance, 20 A output current, 0.6 nF total primary capacitance, and 4:1 turns ratio.

FIG. 6 shows minimum magnetizing current, ZVS transition time and commutation time versus total switch capacitance at 48 V input, 200 kHz, 80 ns dead time, 160 nH output inductance, 20 A output current, and 4:1 turns ratio.

FIG. 5 combines the 20 A soft-switching boundary curve from FIG. 3, and ZVS curve. It can be seen that magnetizing inductance required for ZVS is about 15% lower than the inductance required to just initiate soft switching transition. For lower input voltages, lower magnetizing inductance is required for ZVS.

Typical transition time (t₂-t₁) to charge and discharge output capacitance of all the switches (S1-S6) is much longer than commutation time (t₁-t₀) for magnetizing current to commutate back from the secondary to the primary. FIG. 6 shows these two times as a function of magnetizing current and total equivalent capacitance. It can be seen that when the capacitance is higher, the required minimum magnetizing current is higher. The higher the magnetizing current is, the longer the transition time and the shorter the commutation time. At a typical capacitance 0.6 nF, the transition time is 65 ns, and commutation time is 15 ns.

By adopting ZVS, the effective duty cycle (across the output inductor) is increased based on the circuit components and operating conditions. It can be seen from FIG. 4 that with ZVS, the dead time T_{d}′ is always shorter than hard switching dead time T_{d}′ which is determined by the primary controller. T_{d}′ is determined only by operation conditions and circuit components. This allows circuit designers to change the dead time by using different operation conditions or different circuit components.

With ZVS, the performance of load regulation is improved. The new duty cycle is higher than the primary switching duty cycle since the dead time is shorter. Therefore, at the same load current, with ZVS, the output voltage is higher than that without ZVS. It means that load has less influence on the output voltage under a ZVS condition.

ZVS guarantees the balance of the magnetic flux. For example, assume that there is an imbalance of the flux and the positive magnitude of magnetizing current is higher than the negative magnitude. During the dead time, with higher magnetizing current, the transition time is less. The magnetizing current will automatically increase for the next duty cycle. The higher next duty cycle helps to raise the negative magnitude of the magnetizing current. Therefore, the ZVS circuit forms a negative feedback to prevent the transformer from the imbalance of the magnetic flux due to different pulse widths from the primary switches.

A full-bridge DC bus converter with fixed 50% duty cycle was built [see generally W. Fan and G. Stojcic, “Novel IC Controller for DC Bus Converters,” PCIM China 2003, pp. 206-211] having a planar transformer with PQ cores providing 4:1 voltage conversion ratio and isolation between the primary side and secondary side and modified to include an air gap according to an embodiment of this invention, in this case a 4 mil air gap. A 160 nH output inductor was used on the secondary.

FIG. 7 shows electrical efficiency versus load current at 48 V input voltage and a picture of the converter. The switching frequency of the circuit is 200 KHz. With the ZVS, the efficiency at 20 A is about 0.6% higher than that without ZVS. Due to the higher output duty cycle with ZVS, the output voltage of the converter is 0.2 V higher than for hard-switched case, which indicates that the module with ZVS provides more output power.

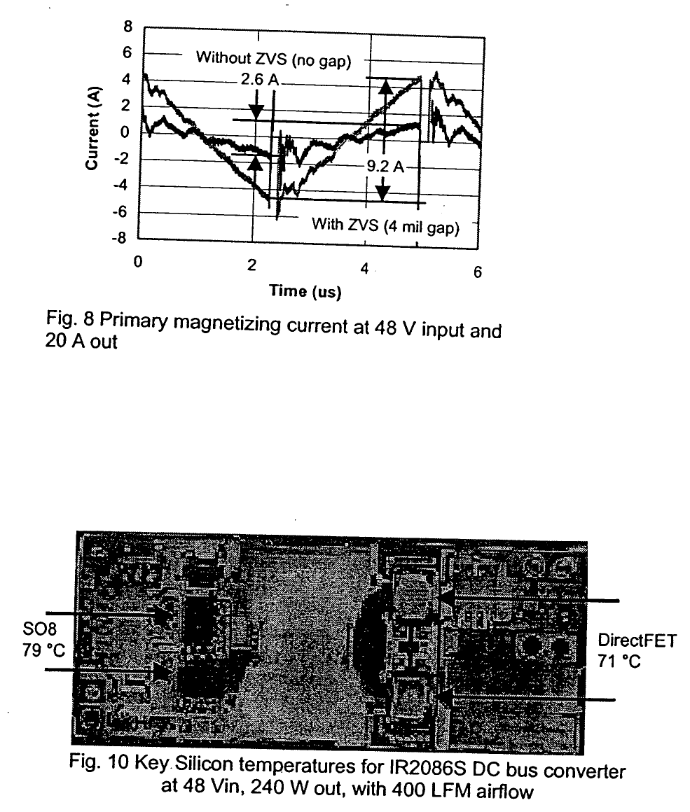

Primary switches have higher magnetizing current with ZVS than that without ZVS. FIG. 8 shows the magnetizing current waveforms for the two cases, calculated from measured primary and secondary current waveforms at 48V input and 20 A out. It can be seen that by adopting ZVS operation, the peak-to-peak primary magnetizing current is increased from 2.6 A to 9.2 A. Therefore, the primary switches have 3.3 A higher peak magnetizing current with ZVS than that without ZVS.

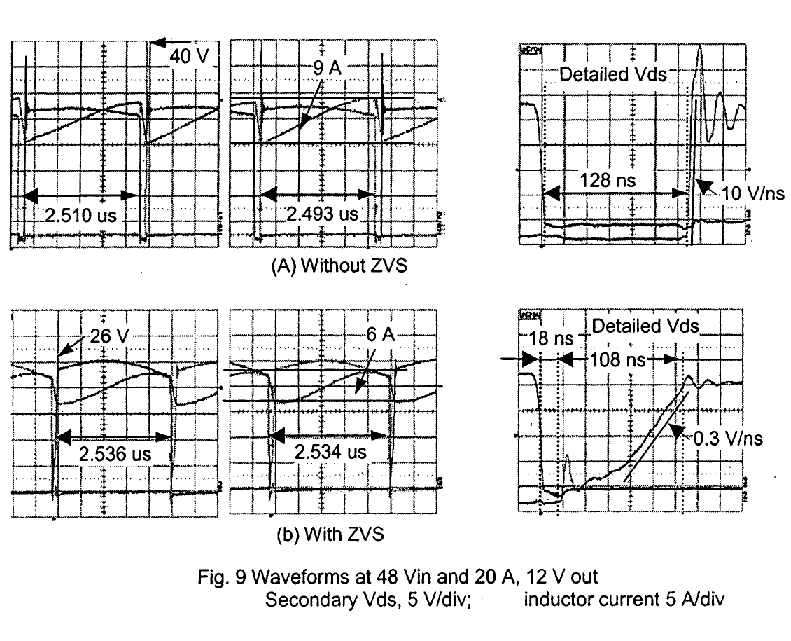

Secondary switches have lower inductor current ripple with ZVS than that without ZVS. Inductor current waveforms are shown in FIG. 9. It can be seen that ZVS operation reduces the inductor current ripple from 9 A to 6 A. This means that primary switches with ZVS have 0.375 A lower peak current ((9−6)/(4*2)), which partially offsets increased magnetizing current. Overall, the peak primary current with ZVS is 2.9 A higher than that without ZVS. Therefore, by adopting the ZVS, the primary side turn-off switching power loss is increased, while the turn-on loss is highly reduced or eliminated.

Voltage spikes on the secondary switches are decreased significantly by adopting ZVS. As shown in FIG. 9, Vds spikes are as high as 40 V without ZVS. With ZVS, the 40 V spike is reduced to about 26 V. 40 V Vds spike is due to body diode reverse recovery. Without ZVS, both secondary switches conduct current through their body diodes during the dead time. When two primary switches are turned on at the end of the dead time, one of the secondary switches has to go through reverse recovery before it can be turned off. This reverse recovery current causes significant voltage spikes across the secondary sync rectifiers. With ZVS, the higher magnetizing current not only forces current through one of the secondary switches to drop to zero, but also charges and discharges output capacitance of all the switches, which turns off the secondary switches slowly. A detailed Vds waveform, shown in FIG. 9, indicates that the Vds dv/dt with ZVS is about 0.3 V/ns, while without ZVS, it can be as high as 10 V/ns.

The pulse widths are well balanced with ZVS. It can be seen that the difference between two consecutive pulses can be as high as 17 ns (2.510 us-2.493 us) without ZVS. With ZVS, the difference can be decreased dramatically from 17 ns to 2 ns (2.536 us-2.534 us). The small difference of the pulse widths guarantees the flux balance of a transformer.

Adopting the ZVS operation decreases the dead time. The dead time is 128 ns without ZVS, as shown in FIG. 9. It is reduced significantly to 18 ns with ZVS. Since the secondary circuit is a self-driven type, the shorter the dead time, the less the body diodes conduct. Therefore, ZVS operation reduces body diode conduction loss for the secondary switches, in addition to elimination of reverse recovery related losses.

Another benefit of ZVS is the core loss in the output inductor. Due to dead time reduction from greater than 100 ns to less than 20 ns, the inductor ripple current as well as flux density are significantly reduced. This results in a drop of inductor temperature by 15° C.

From the detailed ZVS Vds waveforms in FIG. 8, the transition time is 18 ns, and commutation time is 108 ns. The transition time is much higher than the commutations time, which is very consistent with the prediction in FIG. 6.

During the dead time, the inductor current decreases almost linearly, which is consistent with the assumption. However, the current does not increase linearly when the primary switches are on. The reason is simply due to the voltage variation across small input and output ceramic capacitors.

Table 1 shows power loss breakdown when input voltage is 48 V and output 20 A and 12 V. It can be seen that main power loss comes from the transformer and four primary FETs. The transformer loss can be significantly reduced by increasing the cross section area of the core. The primary FET loss can be reduced by replacing the SO8 primary FETs with DirectFETs. For example, IRF6644 DirectFET fits in the same space as IRF7493, but provides over 35% Rds(on) reduction with similar gate charge. Rds(on) reduction is important because ZVS operation increases the rms. current through the primary FETs. The additional benefit of using DirectFET is to reduce primary device temperature, which in present module is close to 10° C. higher than for the secondary DirectFETs (see FIG. 10).

A simple method and circuit arrangement to achieve ZVS in a 50% duty cycle full-bridge DC bus converter has been described. A condition to achieve ZVS is that magnetizing current during dead time, reflected to the secondary side, is higher than the valley of the output inductor ripple current. This allows part of the magnetizing current to commutate back to the primary and discharges the output capacitors of the primary switches.

By adopting the ZVS operation, the body diode conduction of the secondary synchronous rectifiers is greatly reduced, and voltage spikes across the devices are completely eliminated. ZVS increases effective duty cycle of the converter, which improves load regulation, and reduces output inductor current ripple and core loss. ZVS also provides an effective mechanism for maintaining transformer flux balance. ZVS advantages, including a 15% reduction of full-load power loss have been demonstrated on a practical 240 W DC bus converter.

Although the present invention has been described in relation to particular embodiments thereof, many other variations and modifications and other uses will become apparent to those skilled in the art. Therefore, the present invention is not limited by the specific disclosure herein.

What is claimed is:

1. A DC-DC converter comprising:
a plurality of semiconductor switching devices connected in a bridge configuration and controllable to convert a DC source voltage to a primary AC current;
a transformer having a primary, a secondary, and a core; said primary being connected to said bridge for receiving said primary AC current; said secondary outputting a secondary AC current; and a secondary circuit for rectifying said secondary AC current to provide a DC output voltage;
wherein said transformer has an air gap, which increases the magnetizing current in said transformer.

2. A method of improving switching in a DC-DC converter, said converter comprising:
a plurality of semiconductor switching devices connected in a bridge configuration and controllable to convert a DC source voltage to a primary AC current;
a transformer having a primary, a secondary, and a core; said primary being connected to said bridge for receiving said primary AC current; said secondary outputting a secondary AC current; and a secondary circuit for rectifying said secondary AC current to provide a DC output voltage;
the method comprising the step of increasing the magnetizing current in said transformer to thereby support the said primary AC current and discharge output capacitances of said plurality of semiconductor switching devices.

3. A DC-DC converter comprising:
a primary circuit including a plurality of semiconductor switches connected to form a bridge for receiving a DC source voltage and outputting a primary AC current; said switches of said bridge being turned on and off by respective control pulses having dead times defined between said pulses;
a transformer having a primary, a secondary, and a core; said primary being connected to said primary circuit for receiving said primary AC current and outputting a secondary AC current; and
a secondary circuit for rectifying said secondary AC current and providing a DC output voltage;
said transformer having an air gap which causes a magnetizing current of said transformer to circulate to said primary circuit during said dead times so as to support said primary AC current during said dead times.

4. The DC-DC converter of claim 3, wherein said semiconductor switches are FETs having body capacitors, and said magnetizing current discharges said body capacitors.

5. The DC-DC converter of claim 4, wherein said bridge is a full bridge comprising four of said FETs.

6. The DC-DC converter of claim 5, further comprising a primary inductor connected across said transformer primary.

7. The DC-DC converter of claim 3, further comprising a primary inductor connected across said transformer primary.

8. A method of improving primary switching in a DC-DC converter, said DC-DC converter comprising:
a primary circuit including a plurality of semiconductor switches connected to form a bridge for receiving a DC source voltage and outputting a primary AC current; said switches of said bridge being turned on and off by respective control pulses having dead times defined between said pulses;
a transformer having a primary, a secondary, and a core; said primary being connected to said primary circuit for receiving said primary AC current and outputting a secondary AC current; and
a secondary circuit for rectifying said secondary AC current and providing a DC output voltage;
said method comprising the step of increasing a magnetizing current of said transformer and circulating said magnetizing current to said primary circuit during said dead times so as to support said primary AC current during said dead times.

9. The method of claim 8, wherein said semiconductor switches are FETs having body capacitors, and said magnetizing current discharges said body capacitors.

10. The method of claim 9, wherein said bridge is a full bridge comprising four of said FETs.

11. The method of claim 10, further comprising a primary inductor connected across said transformer primary.

12. The method of claim 8, further comprising a primary inductor connected across said transformer primary.

13. The method of claim 2, wherein the magnetizing current in the transformer is increased by providing an air gap in the transformer core.

14. The method of claim 8, wherein the magnetizing current in the transformer is increased by providing an air gap in the transformer core.

15. A DC-DC converter comprising:
a primary circuit comprising a plurality of semiconductor switching devices connected in a bridge configuration and controllable to convert a DC source voltage to a primary AC current;
a transformer having a primary and a secondary; said primary being connected to said primary circuit for receiving said primary AC current; said secondary outputting a secondary AC current; and a secondary circuit for rectifying said secondary AC current to provide a DC output voltage; and
zero voltage switching (ZVS) in said primary circuit.

16. A method of operating a DC-DC converter, said converter comprising:
a primary circuit comprising a plurality of semiconductor switching devices connected in a bridge configuration and controllable to convert a DC source voltage to a primary AC current;
a transformer having a primary and a secondary; said primary being connected to said primary circuit for receiving said primary AC current; said secondary outputting a secondary AC current; and a secondary circuit for rectifying said secondary AC current to provide a DC output voltage;
the method comprising zero voltage switching in said primary circuit.
